(19) United States
(12) Patent Application Publication
(10) Pub. No.: US 2004/0139636 A1
(43) Pub. Date: Jul. 22, 2004

(54) Illuminated signboard

(76) Inventor: Ming Hsien Lin, Kaohsiung Hsien (TW)

Correspondence Address: HUNTON & WILLIAMS LLP, INTELLECTUAL PROPERTY DEPARTMENT, 1900 K STREET, N.W., SUITE 1200, WASHINGTON, DC, 20006-1109, US

(21) Appl. No.: 10/348,025

(22) Filed: Jan. 22, 2003

(51) Int. Cl. G09F 13/18

(52) U.S. Cl. 40/546; 40/547

(57) ABSTRACT

An illuminated signboard includes a light guide panel having a first surface, an opposite second surface, and a lateral wall interconnecting the first and second surfaces. The lateral wall has an incident surface. A lighting device is disposed adjacent the incident surface, and has a frame connected to the light guide panel, and a light source mounted within the frame to supply light towards the incident surface. A pair of transparent cover plates, which have a refractive index smaller than that of the light guide panel, cover respectively the first and second surfaces to return inward the light emanated outward from the first and second surfaces so that the light is efficiently propagated within the light guide panel. One of the cover plates has a pattern that forms a light exiting area.

### BACKGROUND OF THE INVENTION

1. Field of the Invention

The invention relates to an illuminated signboard, more particularly to a low-cost illuminated signboard that provides an excellent advertising or displaying effect.

2. Description of the Related Art

A conventional illuminated signboard generally includes a frame and a panel mounted on the frame. The panel permits light to pass therethrough, and has a pattern provided thereon. A lamp is mounted in a space cooperatively confined by the panel and the frame such that light emitted from the lamp passes through the panel to illuminate the pattern on the panel. However, the aforesaid conventional illuminated signboard has disadvantages of bulkiness, inconvenient lamp replacement, insufficient luminosity, and high costs.

Referring to FIG. 1, a conventional optical fiber signboard 1 is shown to include a display panel 11, a light source 12 and a multiplicity of optical fibers 13. The display panel 11 is provided with a pattern 111 through which light can pass. The light source 12 is disposed adjacent to the display panel 11. The optical fibers 13 are collected into a bundle 131 that is connected to the light source 12. Light emitted from the light source 12 is transmitted to the display panel 11 through the bundle 131 so as to illuminate the pattern 111. Although the conventional optical fiber signboard 1 does not have a bulky size or insufficient luminosity and does not require a lamp as in the aforesaid illuminated signboard, the optical fibers 13 are very costly to manufacture.

FIG. 2 shows a flexible light-guide pipe disclosed in U.S. Pat. No. 6,275,633. The light-guide pipe, which is denoted by the reference numeral 3, utilizes a fiber-optic element 31 having a light incident end 32 and a light emitting end 33 opposite to the light incident end 32. Light incident on the light incident end 32 is guided into the optical fiber element 31 for transmission to the light emitting end 33. The light emitting end 33 is externally connected to a display element 34 (which is illustrated as an A-shaped display cover in the drawing). Light exiting the light emitting end 33 is used to illuminate the display element 34, thereby displaying an image on the display element 34. However, as the light-guide pipe 3 also utilizes optical fibers, it is also very costly to manufacture.

FIG. 3 shows a conventional illuminated signboard 2 that includes a transparent panel body 21, a light reflecting layer 22, and a refracting layer 23. The light reflecting layer 22 is in the form of a predetermined pattern that is disposed on one side of the panel body 21, such as by printing, so as to form a light reflecting film. The refracting layer 23, which is in the form of the predetermined pattern, is printed on one side of the light reflecting layer 22 facing the panel body 21 so as to form a light refracting film. As such, the signboard 2 can display the predetermined pattern when light from a light source is projected thereon. Although the conventional signboard 2 can eliminate the aforesaid disadvantages of the prior art described hereinbefore, during transmission of the light from the light source through the panel body 21, total reflection cannot be achieved, thereby resulting in leakage of light through parts of the signboard 2 that are not provided with the predetermined pattern, which in turn degrades the quality of the displayed pattern.

Therefore, there is a need for an illuminated signboard that can overcome the aforesaid drawbacks associated with the prior art.

### SUMMARY OF THE INVENTION

Therefore, the main object of the present invention is to provide an illuminated signboard that has an excellent display effect and that is relatively inexpensive to manufacture.

Accordingly, an illuminated signboard of the present invention includes:

a light guide panel having a first surface, an opposite second surface, and a lateral wall interconnecting the first and second surfaces, the lateral wall having an incident surface;

a lighting device disposed adjacent the incident surface and having a frame connected to the light guide panel, and a light source mounted within the frame to supply light towards the incident surface; and

a pair of transparent cover plates having a refractive index smaller than that of the light guide panel and covering respectively the first and second surfaces to return inward the light emanated outward from the first and second surfaces so that the light is efficiently propagated within the light guide panel, one of the cover plates having a pattern that forms a light exiting area.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic view of a conventional optical fiber signboard;

FIG. 2 is a schematic view of a flexible light-guide pipe that is disclosed in U.S. Pat. No. 6,275,633;

FIG. 3 is a schematic sectional view of a conventional illuminated signboard;

FIG. 4 is a schematic exploded perspective view of the first preferred embodiment of an illuminated signboard according to the present invention;

FIG. 5 is a schematic view of the first preferred embodiment in use; and

FIG. 6 is a schematic view of the second preferred embodiment of an illuminated signboard according to the present invention.

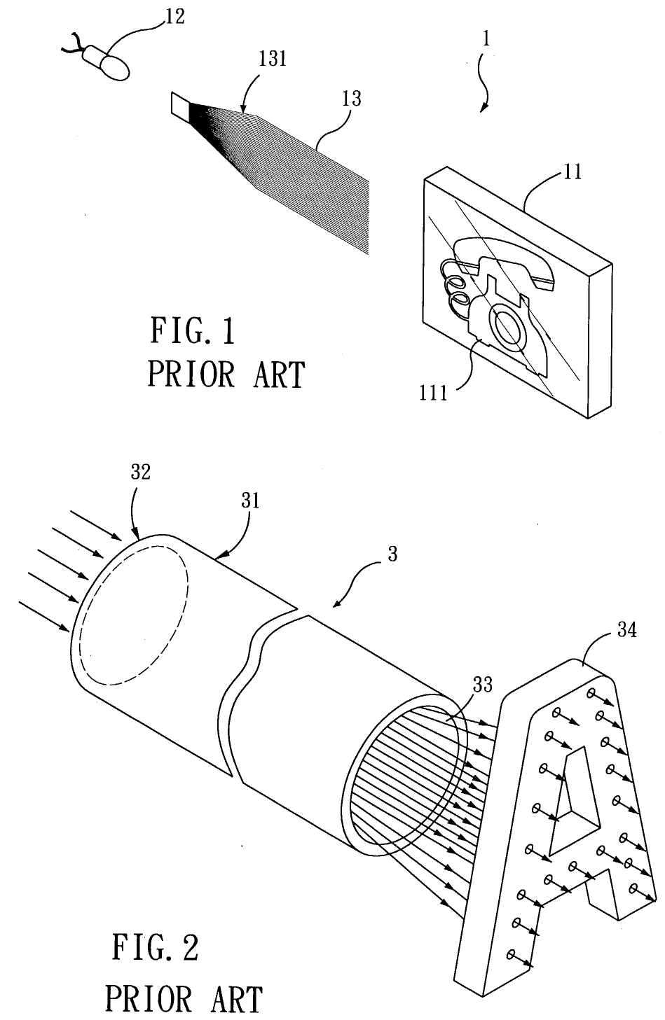

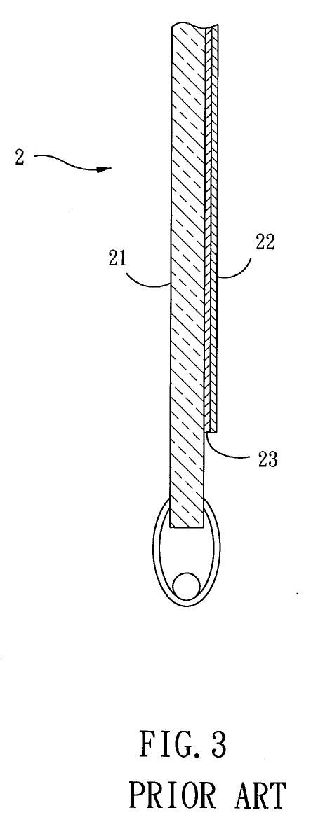

### DETAILED DESCRIPTION OF THE PREFERRED EMBODIMENTS

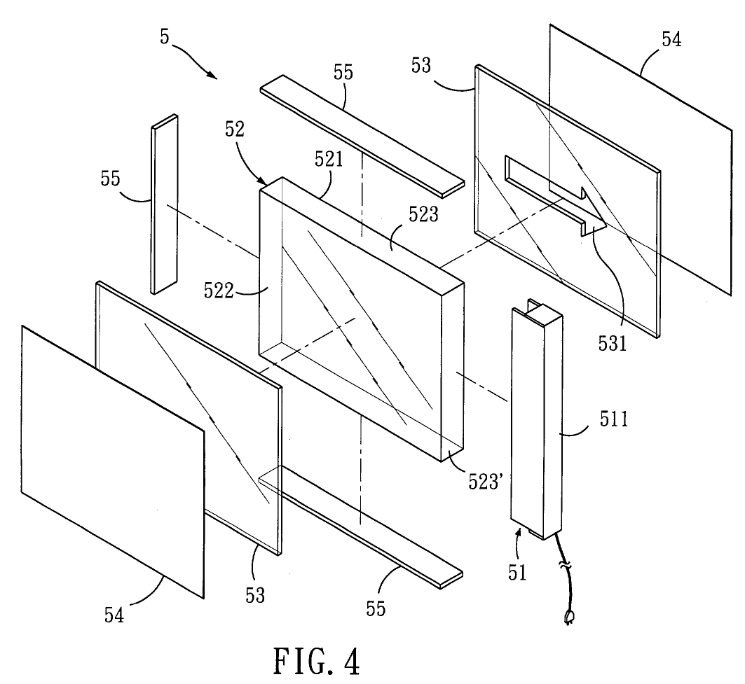

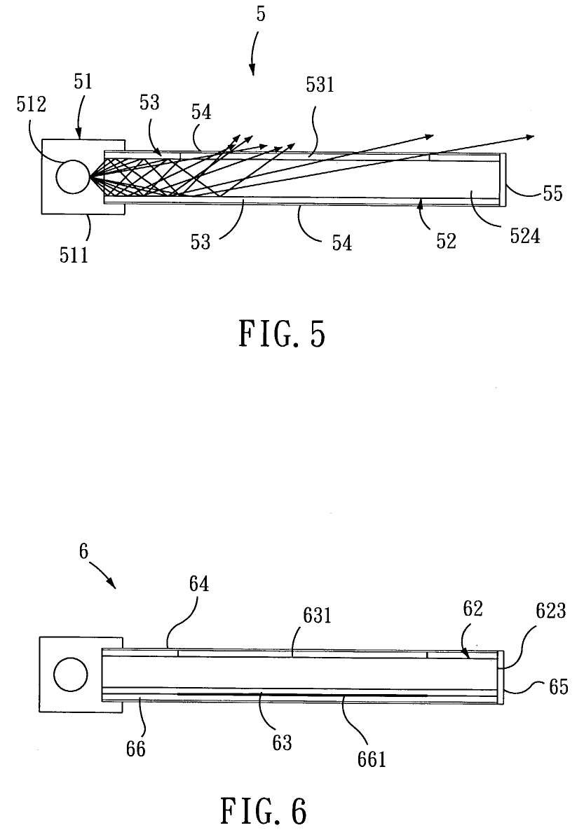

Referring to FIG. 4, the first preferred embodiment of an illuminated signboard 5 according to the present invention is shown to include a lighting device 51, a light guide panel 52, a pair of transparent cover plates 53, a pair of transparent protective plates 54, and a plurality of reflectors 55. The lighting device 51 has a frame 511 and a light source 512 (see FIG. 5), such as a cold cathode fluorescent lamp or a light emitting diode lamp, mounted within the frame 511. The light guide panel 52 is formed from high-molecular polymers with a predetermined refractive index and a predetermined light transmittance by press forming, and having a luminescent dye added thereto such that the light guide panel 52 has a desired luminescent color. The light guide panel 52 is in the form of an elongated plate, and has a first surface 521, a second surface 522 opposite to the first surface 521, and a lateral wall 523 interconnecting the first and second surfaces 521, 522 and having a light incident surface 523′. The first and second surfaces 521, 522, and the lateral wall 523 cooperatively confine a light guiding passage 524 (see FIG. 5). The frame 511 of the lighting device 51 is connected to the light guide panel 52, and is disposed adjacent to the incident surface 523′ so that the light source 512 mounted therein supplies light towards the incident surface 523′.

The transparent cover plates 53 are formed from high-molecular polymers with a predetermined refractive index that is smaller than that of the light guide panel 52, and a predetermined light transmittance, and include a dye such that the cover plates 53 have a color that is different from that of the light guide panel 52. The cover plates 53 are disposed to cover the first and second surfaces 521, 522, of the light guide panel 52, respectively, so that light that enters the light guiding passage 524 of the light guide panel 52 through the incident surface 523′ and that is emanated outward from the first and second surfaces 521, 522 can be returned inward to permit total reflection of the light, thereby achieving efficient propagation of the light within the light guide panel 52. In addition, one of the cover plates 53 has a first pattern 531 formed therein by carving. The first pattern 531 forms a light exiting area that permits passage of a part of the light propagated within the light guiding passage 524 of the light guide panel 52 therethrough. As such, light from the light source 512 exits solely through the first pattern 531 in the corresponding one of the cover plates 53. While the present invention is exemplified herein to have the first pattern 531 formed in one of the cover plates 53, it is noted that each of the cover plates 53 can be formed with the first pattern 531 so as to permit passage of light therethrough.

The protective plates 54 have a predetermined light transmittance, and are disposed to cover the cover plates 53, respectively, so as to protect the cover plates 53 from damage.

The reflectors 55 are disposed to surround entirely the lateral wall 523 of the light guide panel 52 except the incident surface 523′ so as to prevent leakage of light propagated within the light guiding passage 524 of the light guide panel 52 through parts of the lateral wall 523 other than the incident surface 523′. As such, light propagated within the light guiding passage 524 of the light guide panel 52 can only exit through the first pattern 531 in the corresponding one of the cover plates 53, thereby increasing the brightness of the light emanating through the first pattern 531 and hence enhancing the advertising or displaying effect.

Referring to FIG. 5, in use, since the cover plates 53 have a refractive index smaller than that of the light guide panel 52, the light from the light source 512, upon entering the light guiding passage 524 of the light guide panel 52, is propagated within the light guiding passage 524 in a total reflection state, thereby preventing leakage of light through the cover plates 53 and thereby ensuring that light exits from the light guide panel 52 through the first pattern 531 in the corresponding one of the cover plates 53. Furthermore, since the light guide panel 52 includes a luminescent dye, the light emitted therefrom is luminescent. In addition, since the cover plates 53 have a color different from that of the light guide panel 52, the advertising or displaying effect of the signboard 5 of this invention will not diminish even in the daytime.

FIG. 6 shows the second preferred embodiment of an illuminated signboard 6 according to the present invention, which is substantially similar to the previous embodiment in construction. The differences therebetween reside mainly in that the signboard 6 is adapted to be used in an environment where emission of light through only one side of the signboard 6 is desired and that the signboard 6 further comprises a light shielding plate 66. As shown, the light shielding plate 66 is disposed between the cover plate 63 that is not provided with the first pattern 631 and a corresponding one of the protective plates 64, the latter being an optional component of the signboard 6. The light shielding plate 66 is connected to the reflectors 65 on the lateral wall 623 of the light guide panel 62, and is formed with a second pattern 661 that corresponds to the first pattern 631. Preferably, the second pattern 661 has a color which is different from that of the light shielding plate 66 and which contrasts those of the light guide panel 62 and the cover plates 63 such that the first pattern 631 can be viewed with enhanced clarity even in the daytime.

Preferably, a portion of the surface of the light guide panel 62 which corresponds to the first pattern 631 is coated with a light excited powder (not shown) such that light radiating through the first pattern 631 in the corresponding one of the cover plates 63 exhibits a special visual effect to attract attention. As this belongs to the known art, a detailed description thereof is dispensed with herein for the sake of brevity.

It has thus been shown that, by virtue of the construction of the illuminated signboard according to the present invention, the drawbacks associated with the aforesaid prior art can be avoided. At the same time, the advertising or displaying effect of the illuminated signboard can be enhanced.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. An illuminated signboard comprising:
a light guide panel having a first surface, an opposite second surface, and a lateral wall interconnecting said first and second surfaces, said lateral wall having an incident surface;
a lighting device disposed adjacent said incident surface and having a frame connected to said light guide panel, and a light source mounted within said frame to supply light towards said incident surface; and
a pair of transparent cover plates having a refractive index smaller than that of said light guide panel and covering respectively said first and second surfaces to return inward the light emanated outward from said first and second surfaces so that the light is efficiently propagated within said light guide panel, one of said cover plates having a first pattern, said first pattern forming a light exiting area.

2. The illuminated signboard as claimed in claim 1, further comprising a reflector surrounding entirely said lateral wall except said incident surface.

3. The illuminated signboard as claimed in claim 2, wherein said light guide panel has a color different from that of said cover plates.

4. The illuminated signboard as claimed in claim 2, further comprising a light shielding plate disposed over the other one of said cover plates and opposite to said light guide panel.

5. The illuminated signboard as claimed in claim 4, wherein said light shielding plate has a second pattern corresponding to said first pattern.

6. The illuminated signboard as claimed in claim 2, further comprising a pair of transparent protective plates respectively covering said cover plates.

7. The illuminated signboard as claimed in claim 2, further comprising a transparent protective plate covering said one of said cover plates that has said first pattern.

8. The illuminated signboard as claimed in claim 2, wherein said light guide panel includes a luminescent dye.
